(19) United States
(12) Patent Application Publication
(10) Pub. No.: US 2009/0132116 A1
(43) Pub. Date: May 21, 2009

(54) DRIVE SYSTEM FOR ELECTRICALLY DRIVEN DUMP TRUCK

(76) Inventors: Yasuo Tanaka, Yokohama-shi (JP); Tomohiko Yasuda, Kashiwa-shi (JP); Takashi Yagyu, Ushiku-shi (JP); Yutaka Watanabe, Kasumigaura-shi (JP)

Correspondence Address: MATTINGLY & MALUR, P.C., 1800 DIAGONAL ROAD, SUITE 370, ALEXANDRIA, VA, 22314, US

(21) Appl. No.: 12/097,053

(22) PCT Filed: May 18, 2007
(86) PCT No.: PCT/JP2007/060282

§ 371 Date: Jun. 12, 2008

(30) Foreign Application Priority Data
Jun. 6, 2006 (JP) 2006-157617

(51) Int. Cl. H02P 6/04; G06F 7/00

(52) U.S. Cl. 701/36; 318/434

(57) ABSTRACT

A drive system of an electrically driven dump truck that
includes a prime mover, an electric generator, electric motors for traveling, each of which is driven by the electric power supplied from the electric generator 5 and inverters for controlling the electric motors, respectively. A total control unit calculates a correction coefficient Kp in response to the hydraulic fluid temperature detected by a thermometer 20, and then subtracts the horsepower g(Ne) for driving the other prime mover loads, which have been corrected by use of the correction coefficient Kp, from the maximum output horsepower f(Ne) of the prime mover to determine the maximum horsepower Mr that can be used by the electric motors An inverter control unit 7 determines a target torque of the electric motors on the basis of the maximum horsepower Mr so that the inverters are controlled respectively.

### TECHNICAL FIELD

The present invention relates to a drive system for an electrically driven dump truck, such as a drive system for a large dump truck that drives electric motors for traveling by the electric power so as to cause the large dump truck to travel, the electric power being supplied from an electric generator that is driven by a prime mover.

### BACKGROUND ART

Among various kinds of dump trucks, there are electrically driven dump trucks, each of which travels by the driving force acquired by electric motors (refer to patent document 1). In the dump truck described in the patent document 1, each electric motor for traveling uses, as a power source, the electric power that is supplied from an alternating-current generator driven by a prime mover.

Patent document 1: JP-A-2001-107762

### DISCLOSURE OF INVENTION

### Problems to be Solved by the Invention

In the case of the electrically driven dump truck as described above, the prime mover is usually used not only for driving the electric generator, but also for driving load devices other than the electric generator. As an example, the loads other than the electric generator include: a cooling fan for sending air to a radiator; an oil hydraulic pump for driving hydraulic equipment used for, for example, the vessel operation, and the steering operation, of the dump truck; and other electric generators for driving electric fans used to cool a control unit for controlling the traveling operation and the electric motors for traveling. For this reason, the control unit, which is located in the electrically driven dump truck, is often programmed to perform the steps of: reserving, as the loss horsepower (set value), the horsepower that can be used to drive prime mover loads other than the electric generator for supplying the electric power to the electric motors for traveling; and estimating a value obtained by subtracting the loss horsepower from the maximum output horsepower, which can be output by the prime mover, as the maximum horsepower that can be assigned to the electric motors for traveling; and calculating the target horsepower of the electric motors for traveling with this maximum horsepower used as a limit value.

At this time, the loss horsepower, which can be used to drive the prime mover load other than the electric generator, is usually set on the basis of the standard atmospheric temperature, the standard hydraulic fluid temperature, the standard traveling load state, and the standard altitude, all of which are assumed by a manufacturer. However, for example, if the atmospheric temperature is low, the temperature of hydraulic fluid decreases, causing the motive power for driving an oil hydraulic pump to increase, and vice versa. In addition, because air is required for the combustion of fuel in the prime mover, it is natural that the output horsepower of the prime mover decreases under high altitude environment (for example, the altitude is 3000 m).

As a result, for example, the following malfunction occurs. If the environment state quantity under working environment, which is typified by the atmospheric temperature, changes, the excess or deficiency of the assigned amount of the horsepower increases on the loss horsepower side or on the traveling horsepower side. This causes engine stall to easily occur, or in order to prevent the engine stall from occurring, it is forced to estimate the loss horsepower to be more sufficient than necessary.

The present invention was devised taking the above-described situation into consideration. An object of the present invention is to provide a drive system of an electrically driven dump truck that is capable of optimizing the allocation of the horsepower between the traveling horsepower and the loss horsepower other than the traveling horsepower in response to a change in working environment that is typified by the ambient atmospheric temperature.

### Means for Solving the Problems

(1) In order to achieve the above-described object, according to one aspect of the present invention, there is provided a drive system of an electrically driven dump truck that travels using the electric energy. The drive system comprising: a prime mover; an electric generator that is driven by the prime mover; electric motors for traveling, each of which is driven by the electric power supplied from the electric generator; inverters that are connected to the electric generator, and that control the electric motors; other prime mover loads other than the electric generator that is driven by the prime mover; measuring means for measuring the environment state quantity that fluctuates in response to ambient working environment; correction coefficient calculation means for, on the basis of the correlation between the environment state quantity and a correction coefficient, the correlation being provided beforehand, calculating a correction coefficient in response to the environment state quantity detected by the measuring means; horsepower calculation means for calculating the maximum output horsepower that can be output by the prime mover, and the horsepower for driving the other prime mover loads, on the basis of the target revolution speed of the prime mover or the actual revolution speed thereof; maximum horsepower calculation means for correcting the horsepower for driving the other prime mover loads by use of the correction coefficient that has been calculated by the correction coefficient calculation means, and for subtracting the horsepower for driving the other prime mover loads after the correction from the maximum output horsepower that can be output by the prime mover, so as to determine the maximum horsepower that can be used by the electric motors for traveling; and inverter control means for determining the target torque of the electric motors for the traveling on the basis of the maximum horsepower that can be used by the electric motors for traveling, the maximum horsepower having been calculated by this maximum horsepower calculation means, and for controlling the inverters on the basis of the calculated target torque.

(2) In order to achieve the above-described object, according to another aspect of the present invention, there is provided a drive system of an electrically driven dump truck that travels using the electric energy. The drive system comprising: a prime mover; an electric generator that is driven by the prime mover; electric motors for traveling, each of which is driven by the electric power supplied from the electric generator; inverters that are connected to the electric generator, and that control the electric motors; other prime mover loads other than the electric generator, the other prime mover loads being driven by the prime mover; measuring means for measuring the environment state quantity that fluctuates in response to ambient working environment; correction coefficient calculation means for, on the basis of the correlation between the environment state quantity and a correction coefficient, the correlation being provided beforehand, calculating a correction coefficient in response to the environment state quantity detected by the measuring means; corrected horsepower calculation means for calculating the corrected horsepower on the basis of the correction coefficient calculated by the correction coefficient calculation means, and the horsepower for driving the other prime mover loads; reference target horsepower calculation means for calculating the reference target horsepower of the prime mover in response to the operation amount of the accelerator pedal; target horsepower calculation means for calculating the target horsepower of the prime mover by adding the corrected horsepower to the reference target horsepower that has been calculated by the reference target horsepower calculation means; prime-mover target revolution speed calculation means for calculating the target revolution speed of the prime mover on the basis of the target horsepower that has been calculated by the target horsepower calculation means; fuel injection quantity control means for controlling the fuel injection quantity of the prime mover so that the actual revolution speed gets close to the target revolution speed that has been calculated by the prime-mover target revolution speed calculation means; horsepower calculation means for calculating the maximum output horsepower that can be output by the prime mover, and the horsepower for driving the other prime mover loads, on the basis of the target revolution speed of the prime mover or the actual revolution speed thereof; maximum horsepower calculation means for subtracting the horsepower for driving the other prime mover loads from the maximum output horsepower that can be output by the prime mover, so as to determine the maximum horsepower that can be used by the electric motors for traveling; and inverter control means for determining the target torque of the electric motors for the traveling on the basis of the maximum horsepower that can be used by the electric motors for traveling, the maximum horsepower having been calculated by this maximum horsepower calculation means, and for controlling the inverters on the basis of the calculated target torque.

(3) In the above-described item (1) or (2), it is desirable that the environment state quantity includes the temperature of hydraulic fluid used for the other prime mover loads, and that the measuring means include a thermometer for detecting the temperature of the hydraulic fluid.

(4) In any one of the above-described items (1) through (3), it is desirable that the environment state quantity includes the ambient atmospheric pressure, and that the measuring means include a barometer for detecting the atmospheric pressure.

### EFFECTS OF INVENTION

According to the present invention, it is possible to optimize the allocation of the horsepower between the traveling horsepower and the loss horsepower other than the traveling horsepower in response to a change in working environment that is typified by the ambient atmospheric temperature.

### BRIEF DESCRIPTION OF THE DRAWINGS

FIG. 1 is a diagram illustrating an overall configuration of a drive system of an electrically driven dump truck according to one embodiment of the present invention;

FIG. 2 is a functional block diagram illustrating processing steps used in one embodiment of a drive system of an electrically driven dump truck according to the present invention;

FIG. 3 is a flowchart illustrating processing steps used in one embodiment of a drive system of an electrically driven dump truck according to the present invention;

FIG. 4 is a chart illustrating a function Fr(p) showing the relationship between the accelerator operation amount and the target prime mover horsepower, the function Fr(p) being used in one embodiment of a drive system of an electrically driven dump truck according to the present invention;

FIG. 5 is a chart illustrating a function R1(p) showing the relationship between the accelerator operation amount and an acceleration ratio, the function R1(p) being used in one embodiment of a drive system of an electrically driven dump truck according to the present invention;

FIG. 6 is a chart illustrating a function Nr(Fr) showing the relationship between the target prime mover horsepower and the target revolution speed, the function Nr(Fr) being used in one embodiment of a drive system of an electrically driven dump truck according to the present invention;

FIG. 7 is a chart illustrating a function f(Ne) showing the relationship between the revolution speed and output horsepower of a prime mover, and a function g(Ne) showing the relationship between the revolution speed and the other prime mover load loss horsepower, the function f(Ne) and the function g(Ne) being used in one embodiment of a drive system of an electrically driven dump truck according to the present invention;

FIG. 8 is a chart illustrating the relationship K1(Toil) between the hydraulic fluid temperature and a first correction coefficient, the relationship K1(Toil) being used in one embodiment of a drive system of an electrically driven dump truck according to the present invention;

FIG. 9 is a chart illustrating the relationship K2(Patm) between the atmospheric pressure and a second correction coefficient, the relationship K2(Patm) being used in one embodiment of a drive system of an electrically driven dump truck according to the present invention;

FIG. 10 is a chart illustrating the relationship Tmax(ω) between the motor revolution speed and the maximum motor output torque, the relationship Tmax(ω) being used in one embodiment of a drive system of an electrically driven dump truck according to the present invention;

FIG. 11 is a functional block diagram illustrating processing steps used in another embodiment of a drive system of an electrically driven dump truck according to the present invention;

FIG. 12 is a flowchart illustrating processing steps used in another embodiment of a drive system of an electrically driven dump truck according to the present invention;

FIG. 13 is a chart illustrating the relationship between the hydraulic fluid temperature and a correction coefficient, the relationship being used in another embodiment of a drive system of an electrically driven dump truck according to the present invention;

FIG. 14 is a chart illustrating the relationship between the first and second target revolution speed of a prime mover, the relationship being used in another embodiment of a drive system of an electrically driven dump truck according to the present invention; and

FIG. 15 is a chart illustrating the relationship R1(P)′ between the accelerator operation amount and an acceleration ratio, the relationship R1(P)′ being used in a modified example of a drive system of an electrically driven dump truck according to the present invention.

### DESCRIPTION OF REFERENCE NUMBERS

1 Accelerator pedal
2 Retard pedal
3 Total control unit
4 Prime mover
5 Alternating-current generator
6 Rectifying circuit
7 Inverter control unit
8 Chopper circuit
9 Grid resistor
10 Capacitor
11 Detection resistor
12R, 12L Electric motors
13R, 13L Speed reducers
14R, 14L Tires
15R, 15L Electromagnetic pickup sensors
16 Shift lever
18 Other prime mover loads
71R, 71L Torque instruction operation units
72R, 72L Motor control operation units
73R, 73L Inverters
Mr Target motor horsepower
Ne Engine actual revolution speed
Nr Target engine revolution speed
TrR, TrL Target motor torque
ωR, ωL Motor revolution speed

### BEST MODES FOR CARRYING OUT THE INVENTION

Embodiments of the present invention will be described with reference to drawings as below.

First of all, a basic configuration of an electrically driven dump truck, and the operation thereof, will be described.

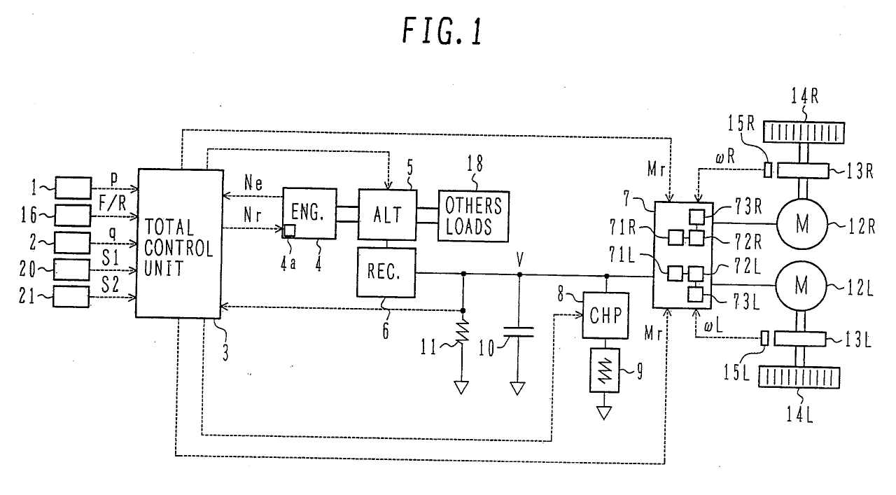

FIG. 1 is a diagram illustrating an overall configuration of a drive system of the electrically driven dump truck according to one embodiment of the present invention.

As shown in FIG. 1, the drive system of the electrically driven dump truck according to this embodiment includes: an accelerator pedal 1; a retard pedal 2; a shift lever 16; a thermometer 20; a barometer 21; a total control unit 3; a prime mover 4; an alternating-current generator 5; other prime mover loads 18; a rectifying circuit 6; an inverter control unit 7; a chopper circuit 8; a grid resistor 9; a capacitor 10; a resistor 11; right and left electric motors (for example, induction motors) 12R, 12L; speed reducers 13R, 13L; tires 14R, 14L; and electromagnetic pickup sensors 15R, 15L. The inverter control unit 7 includes: torque instruction operation units 71R, 71L that are used for the right and left electric motors 12R, 12L respectively; motor control operation units 72R, 72L; and inverters (switching elements) 73R, 73L.

The accelerator pedal 1, the retard pedal 2, an operation signal p of the accelerator pedal 1, and an operation signal q of the retard pedal 2 are inputted into the total control unit 3. The operation signals p and q become a signal for controlling the magnitude of the driving force, and a signal for controlling the magnitude of the retard force, respectively.

When a dump truck is moved forward or backward by pressing down the accelerator pedal 1, the total control unit 3 issues to the prime mover 4 an instruction indicating the target revolution speed Nr. As a result, a signal indicating the actual revolution speed Ne is returned from the prime mover 4 to the control unit 3. The prime mover 4 is a diesel engine that is equipped with an electronic governor 4a. When the electronic governor 4a receives an instruction indicating the target revolution speed Nr, the electronic governor 4a controls the fuel injection quantity so that the prime mover 4 revolves at the target revolution speed Nr.

The alternating-current generator 5 for generating an alternating current is connected to the prime mover 4. The electric power obtained by the alternating current generation is rectified by the rectifying circuit 6, and is then accumulated in the capacitor 10 so that a direct-current voltage value becomes V. The alternating-current generator 5 feeds back a voltage value, into which the direct-current voltage value V is divided by the detection resistor 11. The total control unit 3 controls the alternating-current generator 5 so that the voltage value in question becomes a specified constant voltage value V0.

The electric power generated by the alternating-current generator 5 is supplied to the right and left electric motors 12R, 12L through the inverter control unit 7. By controlling the alternating-current generator 5 so that a direct-current voltage value V, which has been obtained as a result of the rectification by the rectifying circuit 6, becomes the specified constant voltage value V0, the total control unit 3 controls the supply of the electric power so that the electric power required for the electric motors 12R, 12L is supplied.

The horsepower instructions MR, ML of the right and left electric motors 12R, 12L, which are instructed from the total control unit 3, and the rotational speed ωR, ωL of the electric motors 12R, 12L, which is detected by the electromagnetic pickup sensors 15R, 15L, are inputted into the inverter control unit 7. Then, the inverter control unit 7 drives the electric motors 12R, 12L at a slip ratio of greater than 0 through the torque instruction operation units 71R, 71L, the motor control operation units 72R, 72L, and the inverters (switching elements) 73R, 73L respectively.

The right and left tires (rear wheels) 14R, 14L are connected to the electric motors 12R, 12L through the speed reducers 13R, 13L respectively. The electromagnetic pickup sensors 15R, 15L are usually sensors for detecting the peripheral speed of one gear teeth included in the speed reducers 13R, 13L respectively. In addition, for example, if the right side driving system is taken as an example, a gear used for detection may also be given to a driving shaft inside the electric motor 12R, or to a driving shaft to which the speed reducer 13R and the tire 14R are connected, so that the electromagnetic pickup 15R is located at the position of the gear.

When the accelerator pedal 1 is released to press down on the retard pedal 2 during traveling, the total control unit 3 controls the alternating-current generator 5 so that the alternating-current generator 5 does not generate electricity. Moreover, because the horsepower instructions MR, ML issued from the total control unit 3 become negative, the inverter control unit 7 applies the brake force to a car body which travels by driving each of the electric motors 12R, 12L at a slip ratio of lower than 0. At this time, each of the electric motors 12R, 12L acts as an electric generator. Accordingly, each of the electric motors 12R, 12L works so that the capacitor 10 is charged by a rectifying function that is built-into the inverter control unit 7. The chopper circuit 8 works so that the direct-current voltage value V becomes lower than or equal to a predetermined direct-current voltage value V1. As a result, an electric current is fed to the grid resistor 9 to transform the electric energy into the thermal energy.

In addition, although not particularly illustrated, the other prime mover loads 18 include: a cooling fan for sending air to a radiator; an oil hydraulic pump for driving hydraulic equipment used for, for example, the vessel operation and the steering operation, of the dump truck; and other electric generators for driving electric fans used to cool a control unit for controlling the traveling operation and the electric motors for traveling. The thermometer 20 is located in, for example, a hydraulic fluid tank of the oil hydraulic pump. The thermometer 20 detects the temperature of hydraulic fluid stored in the hydraulic fluid tank. In addition, the barometer 21 is located in a driver's seat or at a proper position of a car body. The barometer 21 detects the atmospheric pressure around the dump truck (working environment). The detection signals, which have been detected by the thermometer 20 and the barometer 21, are output to the total control unit 3. In this embodiment, the total control unit 3 calculates the traveling horsepower of the dump truck (or other prime mover loads) by use of the detection signals, each of which indicates the environment state quantity (the details will be described later).

Next, characteristic parts of the present invention will be described.

According to the present invention, operation of each component is subjected to arithmetic processing according to processing steps stored in a memory, which is not illustrated. The memory is built into the total control unit 3 and the inverter control unit 7.

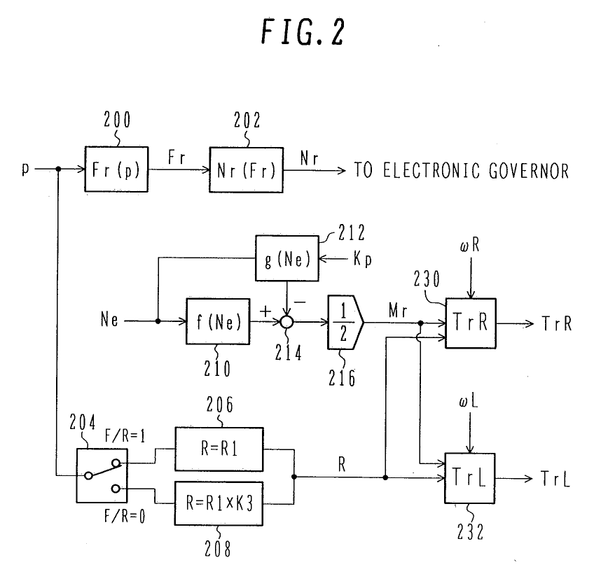

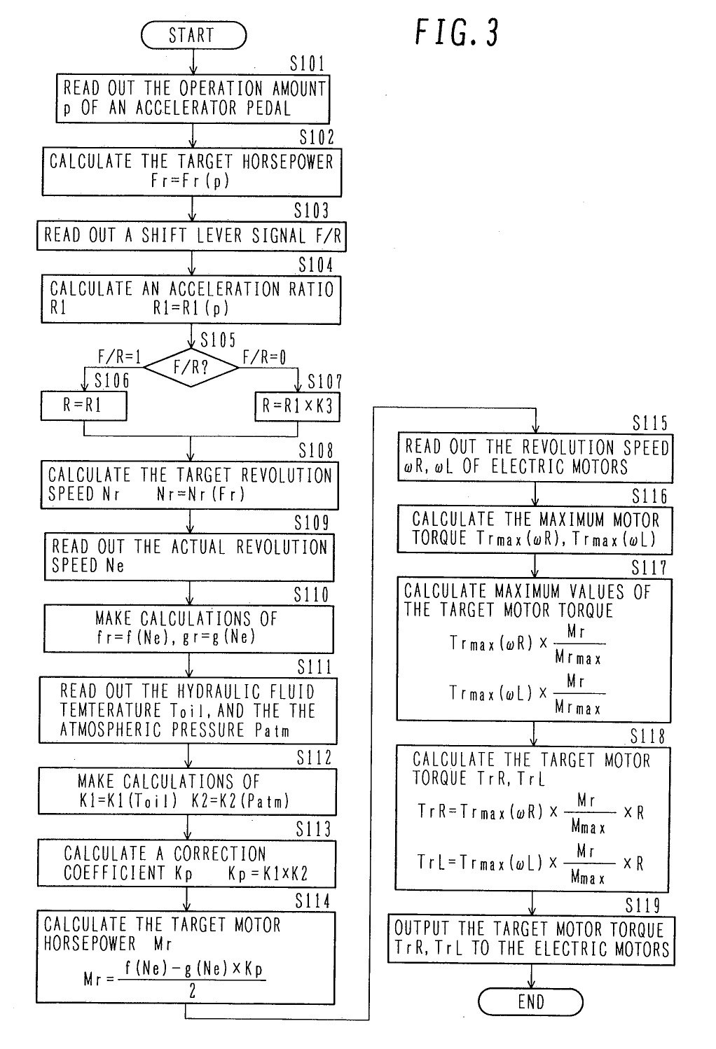

FIG. 2 is a functional block diagram illustrating the processing steps. FIG. 3 is a flowchart illustrating the processing steps. With proper reference to the block diagram shown in FIG. 2, the processing steps will be described according to the flowchart shown in FIG. 3 as below.

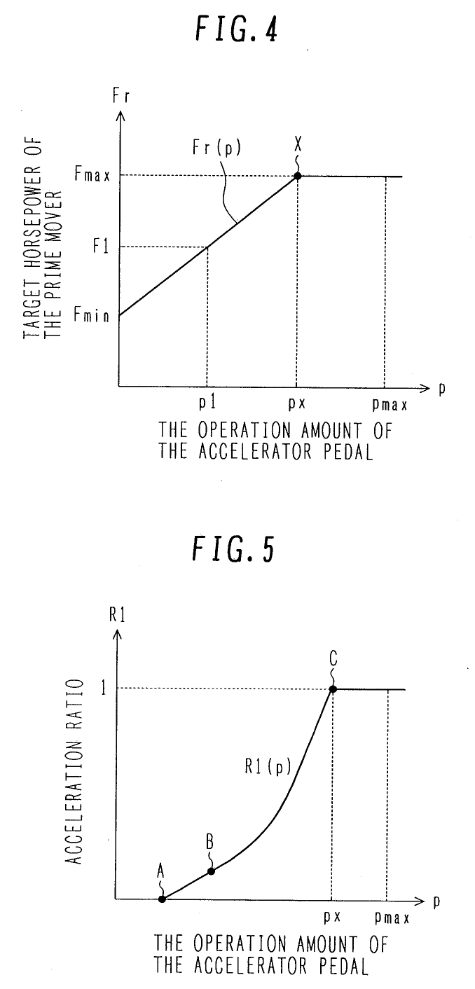

First of all, in steps 101, 102, the total control unit 3 reads out the accelerator pedal operation amount (hereinafter referred to as the accelerator operation amount) p, and then calculates the target prime mover horsepower Fr corresponding to the read accelerator operation amount p on the basis of a data map stored in a memory. The data map shows the relationship between the accelerator operation amount and the target prime mover horsepower, the relationship being defined by a function Fr(p) shown in FIG. 4 (in a block 200 shown in FIG. 2). The function Fr(p) is so configured that if the accelerator operation amount p changes from 0, which means no operation, to the maximum operation amount pmax, a target horsepower Fr of the prime mover 4 changes from the minimum horsepower Fmin to the maximum horsepower Fmax as shown in FIG. 4. For example, in FIG. 4, if the accelerator operation amount is p1, Fr is equivalent to F1 (Fr=F1). In addition, at a point X at which the accelerator operation amount p is lower than pmax, the target prime mover horsepower Fr reaches Fmax that is the maximum. The accelerator operation amount px at the point X is, for example, about 90% of the maximum operation amount pmax.

When the process proceeds to the step 103, the total control unit 3 inputs the state quantity (a shift lever signal F/R) that indicates a state of a position of the shift lever 16. There are three switching positions of the shift lever 16, which are N (neutral), F (forward), and R (reverse). However, because the traveling control is not performed at the neutral position, a signal which is inputted into the total control unit 3 at the time of the driving control is a signal for judging whether the shift lever 16 is set at the forward position or the reverse position. In this example, if the shift lever 16 is set at the forward position, the shift lever signal F/R has a value of 1 (F/R=1). On the other hand, if the shift lever 16 is set at the reverse position, the shift lever signal F/R has a value of 0 (F/R=0).

In a step 104, the total control unit 3 reads out an acceleration ratio R1 from a data map stored in an unillustrated memory. The data map shows the relationship between the accelerator operation amount and an acceleration ratio, the relationship being defined by a function R1(p) shown in FIG. 5. In this example, when the acceleration amount p=0, the acceleration ratio R1 is equivalent to 0 (R1=0). In a state in which the accelerator pedal is slightly pressed down (more specifically, from a point A shown in the figure), the acceleration ratio R1 increases. Then, an increase rate of the acceleration ratio R1 increases from a point B, and at pc (a point C) at which the acceleration amount is lower than the maximum value pmax, the acceleration ratio R1 becomes a maximum value (=1).

In steps 105 through 107, the total control unit 3 uses the acceleration ratio R1 to judge that the shift lever is set at the forward position or at the reverse position. On the basis of the judgment, the total control unit 3 calculates an acceleration ratio R. In a step 105, a judgment is made as to whether the shift lever signal F/R has a value of 1 (forward) or 0 (reverse). If it is judged that the shift lever signal F/R has a value of 1 (F/R=1) (that is to say, forward), the process proceeds to the step 106 where the acceleration ratio R1, which has been read out in the step 104, is set as a value of the acceleration ratio R just as it is. On the other hand, if it is judged that the shift lever signal F/R has a value of 0 (F/R=0) (that is to say, reverse), the process proceeds to the step 107 where a value, which is obtained by multiplying R1 by a predetermined positive constant K3 whose value is smaller than 1 (=K3×R1), is set as a value of the acceleration ratio R.

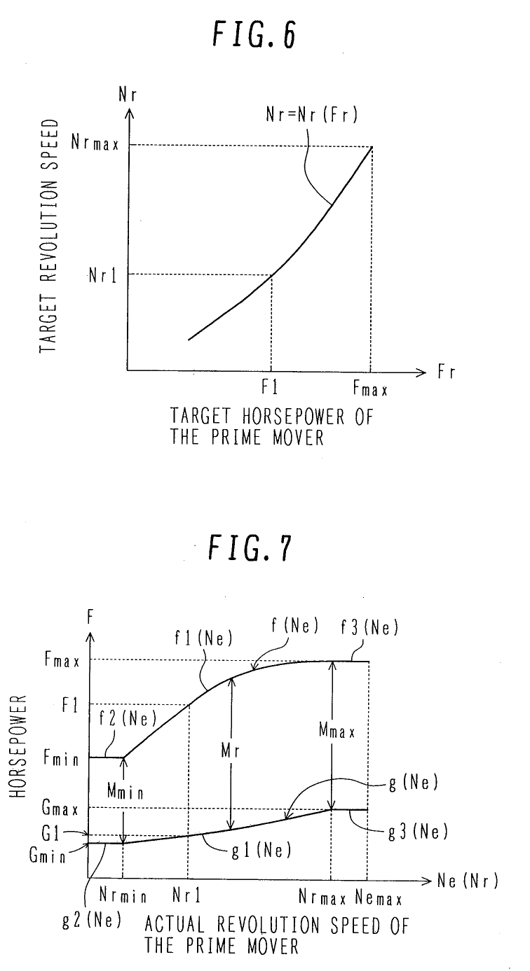

In a step 108, the total control unit 3 calculates the target revolution speed Nr of the prime mover 4 corresponding to the target prime mover horsepower Fr on the basis of a data map stored in the memory (a block 202 shown in FIG. 2). The data map shows the relationship between the target horsepower and the target revolution speed, the relationship being defined by a function Nr(Fr) shown in FIG. 6. Here, the function Nr(Fr) shown in FIG. 6 is an inverse function of the function fr=f(Nr) of the relationship between the target revolution speed of the prime mover 4 and the output horsepower, which will be described later. For example, in FIG. 6, if the target prime-mover horsepower is F1, Nr=Nr1. On the other hand, if the target prime mover horsepower is Fmax, Nr=Nrmax (for example, 2000 rpm). The target revolution speed Nr is transmitted to the prime mover 4 as an instruction of the electronic governor 4a. As a result, the prime mover 4 is driven so that the prime mover 4 revolves at the target revolution speed Nr.

Proceeding to a step 109, the total control unit 3 reads out the actual revolution speed Ne of the prime mover 4. In addition, in a step 110, the total control unit 3 calculates the maximum output horsepower f(Ne) of the prime mover 4 corresponding to the actual revolution speed Ne of the prime mover 4, and the loss horsepower g(Ne) of the other prime mover loads 18 corresponding to the actual revolution speed Ne of the prime mover 4, on the basis of both a data map stored in the memory, the data map showing the relationship between the revolution speed and the maximum output horsepower of the prime mover, the relationship being defined by a function f(Ne) shown in FIG. 7, and a data map stored in the memory, the data map showing the relationship between the revolution speed and the other prime mover load loss horsepower, the relationship being defined by a function g(Ne) shown in FIG. 7 (blocks 210, 212 shown in FIG. 2).

Here, the functions f(Ne) and g(Ne) are created in the following manner. In FIG. 7, the function f(Ne) is used to determine the maximum output horsepower that can be generated by the prime mover 4. Here, the function f1(Ne), the function f2(Ne), and the function f3(Ne) are combined into the function f(Ne). The function f1(Ne) is equivalent to the function fr=f(Nr) of the relationship between the target revolution speed Nr and the output horsepower of the prime mover 4. If the actual revolution speed Ne of the prime mover 4 changes from Nrmin (for example, 750 rpm) up to Nrmax (for example, 2000 rpm), the maximum output horsepower f(Ne) which can be generated by the prime mover 4 changes from the minimum value Fmin up to the maximum value Fmax. This is a diagram illustrating a characteristic line that is specific to the prime mover 4. The function f2(Ne) is based on the assumption that the maximum output horsepower f(Ne) of the prime mover 4 is kept at a constant value of f2=Fmin within a range of 0≦Ne<Nrmin. The function f3(Ne) is based on the assumption that the maximum output horsepower f(Ne) of the prime mover 4 is kept at a constant value of f3=Fmax within a range of Nrmax<Ne≦Nemax.

Although not particularly illustrated, the prime mover 4 drives not only the alternating-current generator 5, but also a cooling fan, an oil hydraulic pump, other electric generators (the second electric generator), and the like. The cooling fan sends air to a radiator so as to cool coolant for cooling an engine, or the like. The oil hydraulic pump discharges pressure oil to drive hydraulic equipment that is used to move a vessel of the dump truck up and down, and that is used to perform steering operation. The other electric generators drive electric fans for cooling the electric motors 12R, 12L and the control units 3, 7. In FIG. 1, these components are illustrated as the other prime mover loads 18. Horsepower values, which are assigned beforehand to drive the other prime mover loads 18, are expressed by g(Ne) shown in FIG. 7. In order to prevent engine stall from occurring at the time of traveling, the horsepower g(Ne) is set at values which are slightly larger than those of the horsepower actually consumed by the other prime mover loads 18 so that a sufficient margin of the horsepower g(Ne) is left. In this specification, this horsepower is called the loss horsepower.

As is the case with the function (Ne), the function g1(Ne), the function g2(Ne), and the function g3(Ne) are combined into the loss horsepower g(Ne). In the case of the function g1(Nr), if the actual revolution speed Ne of the prime mover 4 changes from Nrmin (for example, 750 rpm) up to Nrmax (for example, 2000 rpm), the loss horsepower g1 (Ne) changes from the minimum value Gmin up to the maximum value Gmax. The function g2(Ne) is based on the assumption that the loss horsepower g(Ne) is kept at a constant value of g2=Gmin within a range of 0≦Ne<Nrmin. The function g3(Ne) is based on the assumption that the loss horsepower g(Ne) is kept at a constant value of g3=Gmax within a range of Nrmax<Ne≦Nemax.

In FIG. 7, M, which is defined as the difference (f(Ne)−g(Ne)) between f(Ne) and g(Ne), is the total effective maximum horsepower that can be used by the electric motors 12R, 12L. In other words, M (=f(Ne)−g(Ne)) is the maximum horsepower (an assigned horsepower value) that can be used by the electric motors 12R, 12L, which are used for traveling, out of the maximum output horsepower f(Ne) that can be generated by the prime mover 4. Therefore, the target motor horsepower Mr per electric motor, which will be described later, can be estimated to be M/2. However, in this example, a correction coefficient Kp, which is determined in subsequent steps 111 through 113, is used to calculate the target motor horsepower Mr, and accordingly, the target motor horsepower Mr is corrected in response to the environment state quantity (in this example, the temperature of hydraulic fluid, and the atmospheric pressure).

In the steps 111 through 113, the total control unit 3 determines the correction coefficient Kp.

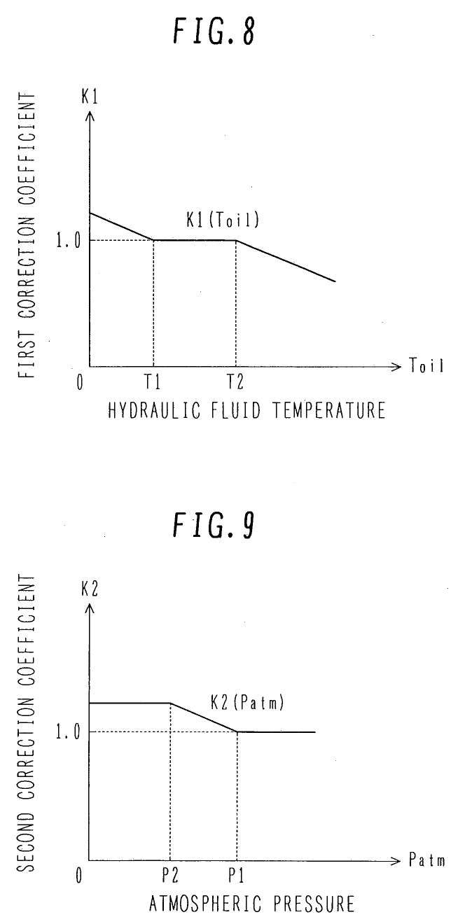

In the step 111, the total control unit 3 calculates the hydraulic fluid temperature Toil from a detection signal S1 of the thermometer 20 that is mounted to a hydraulic fluid tank, hydraulic piping, or hydraulic equipment, which is not illustrated, and also calculates the atmospheric pressure Patm from a detection signal S2 of the barometer 21 that is mounted to a main body of the dump track. Next, in the step 112, with reference to a memory map showing the relationship between the hydraulic fluid temperature and a first correction coefficient shown in FIG. 8, the total control unit 3 determines a first correction coefficient K1 in response to the calculated hydraulic fluid temperature Toil. Then, with reference to a memory map showing the relationship between the atmospheric pressure and a second correction coefficient shown in FIG. 9, the total control unit 3 determines a second correction coefficient K2 in response to the calculated atmospheric pressure Patm. After that, proceeding to the step 113, the total control unit 3 multiplies the correction coefficient K1 by the correction coefficient K2 to calculate the correction coefficient Kp (=K1×K2).

In this embodiment, the first correction coefficient K1 is so configured that when the hydraulic fluid temperature Toil is lower than or equal to the predetermined standard temperature T1, and at the same time, when the hydraulic fluid temperature Toil is higher than the set temperature T2 that is lower than the standard temperature T1, the first correction coefficient K1 is kept at a constant value (=1.0), and that when the hydraulic fluid temperature Toil is lower than or equal to the set temperature T2, the first correction coefficient K1 increases with the decrease in oil temperature, and that when the hydraulic fluid temperature Toil exceeds the standard temperature T1, the first correction coefficient K1 decreases with the increase in oil temperature. In addition, the second correction coefficient K2 is so configured that when the atmospheric pressure Patm is higher than or equal to the predetermined standard atmospheric pressure P1 (for example, 1 atmospheric pressure), the second correction coefficient K2 is kept at a constant value (=1.0), and that when the atmospheric pressure Patm is lower than the standard atmospheric pressure P1, and at the same time, when the atmospheric pressure Patm is higher than or equal to the set atmospheric pressure P2 (<P1), the second correction coefficient K2 gradually increases from 1.0, whereas when the atmospheric pressure Patm is lower than the set atmospheric pressure P2, the second correction coefficient K2 becomes a constant value (>1.0). However, the settings of the correction coefficients K1, K2 are not limited to those in the modes shown in FIGS. 8, 9. The settings can be properly changed.

Proceeding to a step 114, on the basis of the maximum output horsepower f(Ne) of the prime mover, which has been calculated in the step 110, the loss horsepower g(Ne) assigned to the other prime mover loads 18, and the correction coefficient Kp calculated in the step 113, the total control unit 3 determines the target motor horsepower Mr per electric motor by use of the following equation (blocks 214, 216 shown in FIG. 2):

Mr={f(Ne)−g(Ne)×Kp}/2

This target motor horsepower Mr is the maximum horsepower that can be assigned to each of the electric motors 12R, 12L. By limiting the horsepower, which is assigned to each of the electric motors 12R, 12L, to the target motor horsepower Mr, it is possible to prevent engine stall from occurring at the time of traveling.

Next, proceeding to steps 115, 116, 117, 118, the inverter control unit 7 calculates the target motor torque TrR, TrL used to drive the electric motors 12R, 12L respectively (blocks 230, 232 shown in FIG. 2). Incidentally, components which take charge of the control processing are not limited to those described in this example. However, in this embodiment, the control processing up to the step 114 (the blocks 200, 202, 204, 206, 208, 210, 212, 214, 216) is processing performed by the total control unit 3. On the other hand, the control processing in the steps 115 and after (the blocks 230, 232) is processing performed by the torque instruction operation units 71R, 71L of the inverter control unit 7. In addition, even if it is so configured that one control means controls the whole control processing, no problem arises.

First of all, in the step 115, the inverter control unit 7 inputs and reads out the revolution speed ωR, ωL of the electric motors 12R, 12L that have been detected by the electromagnetic pickup sensors 15R, 15L respectively.

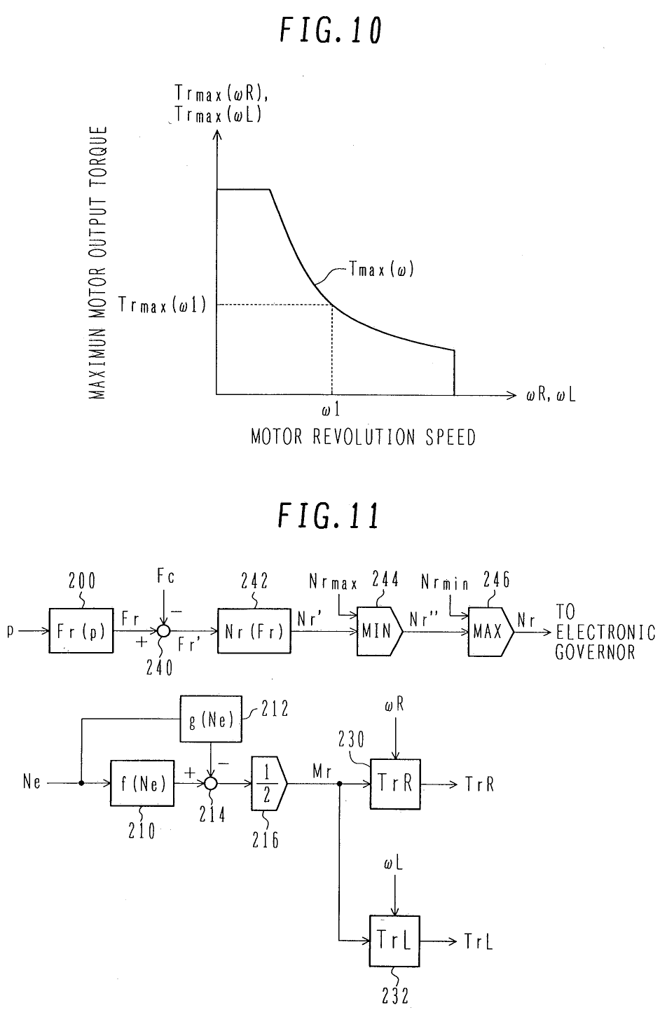

Next, in the step 116, with reference to a chart showing the relationship between the motor revolution speed and output torque of the electric motors 12R, 12L, the relationship being expressed by a function Tmax(ω) shown in FIG. 10, the maximum motor torque Trmax(ωR), Trmax(ωL) is determined. Values of the maximum motor torque Trmax(ωR), Trmax(ωL) are upper limits of a motor torque instruction corresponding to the revolution speed ωR, ωL of the electric motors 12R, 12L respectively. For example, when the motor revolution speed ωR, ωL is ω1, the maximum motor torque Trmax(ωR), Trmax(ωL) becomes Trmax(ω1) respectively. The function Tmax(ω) is a data map showing the relationship between the revolution speed of each motor and the maximum output torque of the each motor, corresponding to the maximum value Mmax of the output horsepower M of the electric motors 12R, 12L. The function Tmax(ω) is predetermined on the basis of the maximum value of current which the inverters 73R, 73L can supply to the electric motors 12R, 12L, an output limit of a driver element such as IGBT or GTO included in the inverters 72R, 72L, the intensity of each motor shaft, and the like.

In the step 117, reference values of the target motor torque are calculated. Here, by multiplying the maximum motor torque Trmax(ωR), Trmax(ωL) by a ratio of the target motor horsepower Mr determined in the step 114 to the maximum horsepower Mrmax that can be assigned to each electric motor determined in FIG. 7, maximum values of the target motor torque are calculated as shown in the following numerical expressions:

Tr max(ωR)×Mr/Mr max

Tr max(ωL)×Mr/Mr max

By multiplying the maximum motor torque Trmax(ωR), Trmax(ωL) by the ratio of the target motor horsepower Mr to the maximum horsepower Mrmax that can be assigned to each electric motor, in other words, by making a proportional calculation, a maximum value of the target motor torque is calculated.

Then, in the step 118, the maximum value of the target motor torque calculated in the step 117 is multiplied by the acceleration ratio R to calculate the target motor torque TrR, TrL to be instructed to the electric motors 12R, 12L respectively, the calculation being shown in the following equations:

TrR=Tr max(ωR)×(Mr/Mr max)×R

TrL=Tr max(ωL)×(Mr/Mr max)×R

To be more specific, an instructed value of the target motor torque is optimized on the basis of the acceleration amount and a position of the shift lever 16 here. The acceleration ratio. R is a value that is set with respect to the acceleration amount in consideration of, for example, how to achieve the higher energy efficiency by the horsepower that is actually assigned to the electric motors 12R, 12L with the maximum value of the target motor torque used as a limit. For example, in this example, when the acceleration amount is larger than or equal to pc shown in FIG. 5, more specifically, when the acceleration amount is equivalent to, or close to, the maximum value, the acceleration ratio R is equivalent to 1 (R=1) at the time of traveling forward. Therefore, the maximum value of the target motor torque determined in the step 118 is instructed to the electric motors 12R, 12L just as it is. In contrast, at the time of traveling backward, or when the acceleration amount is lower than pc, the acceleration ratio R=R1×K3 (<1). Therefore, the maximum value of the target motor torque determined in the step 118 is decreased in response to a traveling direction or the acceleration amount, and then the decreased maximum value is instructed to the electric motors 12R, 12L.

In a step 119, the motor control operation units 72R, 72L included in the inverter control unit 7 control the inverters 73R, 73L in response to the target motor torque TrR, TrL so that the torque of the electric motors 12R, 12L is controlled respectively. Then, this step ends. After that, the total control unit 3 and the inverter control unit 7 repeatedly execute the above-described steps 101 through 119 to perform the driving control of the dump truck.

Next, the operation according to this embodiment will be described with reference to the functional block diagram shown in FIG. 2.

### 1. Forward Traveling

When the accelerator pedal 1 is pressed down with the shift lever 16 kept at a forward traveling position, the total control unit 3 calculates the target horsepower Fr of the prime mover 4 (the block 200), and then calculates the target revolution speed Nr (refer to not only the block 202 but also FIG. 6). When an instruction of this target revolution speed Nr is output to the electronic governor 4a (refer to FIG. 1), the electronic governor 4a controls the fuel injection quantity so that the prime mover 4 rotates at the target revolution speed Nr. At the same time, because the shift lever signal F/R received from the shift lever 16 is equivalent to 1 (F/R=1) at the time of forward traveling, the processing function of the block 206 is selected in the block 204. Then, in the block 206, the acceleration ratio (R=R1) of the electric motors 12R, 12L is calculated.

As a result, the total control unit 3 determines the target revolution speed Nr of the prime mover 4 with reference to the functions f(Ne), g(Ne) shown in FIG. 7 to calculate values of f(Ne), g(Ne) (the blocks 210, 212). At this time, on the basis of the hydraulic fluid temperature Toil and the atmospheric pressure Patm that have been received from the thermometer 20 and the barometer 21 respectively, the total control unit 3 calculates the correction coefficient Kp for correcting, in response to the environment state quantity, a ratio of motive power to be supplied to the electric motors 12R, 12L. Then, on the basis of the correction coefficient Kp and the values of f(Ne), g(Ne), the total control unit 3 calculates the target motor horsepower Mr per electric motor (the maximum horsepower that can be used by one electric motor) (the blocks 214, 216).

When the total control unit 3 outputs the target motor horsepower Mr to the inverter control unit 7 (also refer to FIG. 1), the torque instruction operation units 71R, 71L included in the inverter control unit 7 input the motor revolution speed ωR, ωL (detected values) from the electromagnetic pickup sensors 15R, 15L respectively, and then calculates the maximum motor torque Trmax(ωR), Trmax(ωL) corresponding to the input values with reference to the chart shown in FIG. 10. Next, on the basis of the maximum motor torque Trmax(ωR), Trmax(ωL), the target motor torque (maximum value) is calculated by the proportional calculation that uses the target motor horsepower Mr. Then, the target motor torque is multiplied by the acceleration ratio R to determine the target motor torque TrR, TrL (the blocks 230, 232).

The target motor torque TrR, TrL is given as the instructed horsepower of the electric motors 12R, 12L to the motor control operation units 72R, 72L included in the inverter control unit 7 respectively. Then, the inverters 73R, 73L are controlled according to the target motor torque TrR, TrL so that the torque of the electric motors 12R, 12L is controlled respectively. In the description of the operation, the dump truck is kept in the forward traveling state. Therefore, if the acceleration amount is higher than or equal to pc shown in FIG. 5, R becomes equivalent to 1 (R=1), and accordingly, the target motor torque is output at a maximum value.

### 2. Backward Traveling

When the dump truck is moved backward, the accelerator pedal 1 is pressed down with the shift lever 16 kept at a position that instructs the backward traveling. In this case, because the shift lever signal F/R received from the shift lever 16 is equivalent to 0 (F/R=0), the processing function of the block 208 is selected in the block 204. Then, in the block 208, the acceleration ratio (R=R1×K3) of the electric motors 12R, 12L is calculated. The operation other than the above operation is the same as that at the time of forward traveling. However, at the time of backward traveling, the calculation is made by multiplying a coefficient K3 whose acceleration ratio R is lower than 1. Therefore, even if the target torque TrR, TrL which is output to the electric motors 12R, 12L eventually results in the same acceleration amount, it is possible to reduce each of the target torque TrR, TrL to a value that is K3 times as much as that obtained at the time of forward traveling.

Next, effects of this embodiment will be described.

As described above, the total control unit 3 of the electrically driven dump truck as described above reserves, as the loss horsepower g(Ne), the horsepower for driving the other prime mover loads 18 excluding the alternating-current generator 5 for supplying power to the electric motors for traveling. Then, the total control unit 3 estimates the value Mr, which is obtained by subtracting the loss horsepower g(Ne) from the maximum output horsepower f(Ne) that can be generated by the prime mover 4, as the maximum horsepower that can be assigned to the electric motors 12R, 12L for traveling. At this time, according to this embodiment, in consideration of the fluctuations in motive power to be reserved as the loss horsepower g(Ne) that is caused by a change in the environment state quantity under working environment, such as the temperature and the atmospheric pressure, the loss horsepower g(Ne) for driving the other prime mover loads 18 is corrected by use of the correction coefficient Kp in response to the hydraulic fluid temperature Toil, the ambient atmospheric pressure Patm, and the like, before the loss horsepower g(Ne) is subtracted from the maximum output horsepower f(Ne) that can be generated by the prime mover 4.

As a result, the estimation of the loss horsepower g(Ne) is optimized in response to the change in the environment state quantity under working environment. Therefore, it is possible to control the excess or deficiency of the assignment of the loss horsepower g(Ne), and accordingly, it is possible to estimate the maximum horsepower Mr, which is supplied to the traveling side, as much as possible within a range within which engine stall does not occur. Therefore, in response to a change in working environment, which is typified by the ambient atmospheric temperature, it is possible to optimize the allocation of the horsepower between the traveling horsepower and the loss horsepower other than the traveling horsepower. This makes it possible to satisfactorily drive motors without depending on an operation state and a place where the operation is performed, and thereby to stably operate the electrically driven dump truck.

In addition, in the case of the conventional electrically driven dump trucks, for example, when an electrically driven dump truck travels in a place where the atmospheric temperature is extremely low, the horsepower which can be extracted from the prime mover largely changes. Accordingly, in order to prevent engine stall from occurring, a ratio of the horsepower, which is assigned to the driving of electric motors for traveling, to the output of the prime mover tends to be set at a considerably low level. According to circumstances, the traveling horsepower tends to be limited more than necessary. Also for this problem, according to this embodiment, even if the atmospheric temperature fluctuates, the hydraulic fluid temperature, which fluctuates in response to the fluctuates in atmospheric temperature, is used as the environment state quantity to calculate the target motor torque. Accordingly, the traveling horsepower is not limited more than necessary.

Other effects of this embodiment will be described as below.

If the target motor torque is directly calculated from the operation amount p of the accelerator pedal 1, when the operation amount of the accelerator pedal 1 is small, all of the target revolution speed of the prime mover 4, the horsepower applied to the electric motors 12R, 12L, and the torque become small. Accordingly, the required horsepower which is applied to the electric motors 12R, 12L is not so large. However, if it is necessary to achieve sufficient torque (for example, when traveling along an upward slope is started), a driver is required to fully press down the accelerator pedal 1 because only slightly pressing down the accelerator pedal 1 results in insufficient torque. However, if the driver's operation is delayed as a result of confusion, there is also a possibility that the dump truck will move backward because of the tare weight thereof.

In contrast, in this embodiment, when an instructed value of the electric motors 12R, 12L is calculated, the target motor horsepower Mr is first determined (blocks 210 through 216 shown in FIG. 2). Then, on the basis of this target motor horsepower Mr, the target torque TrR, TrL is finally calculated by use of the motor revolution speed ωR, ωL at this point of time (blocks 230, 232 shown in FIG. 2). As a result, when the motor revolution speed of each of the electric motors 12R, 12L is low, even if the operation amount of the accelerator pedal 1 is small, with the result that the horsepower applied to each of the electric motors 12R, 12L is small, it is possible to set each of the target motor torque TrR, TrL, which is a final instructed value, at a high level. Therefore, it is possible to improve the malfunction (for example, at the time of traveling up a slope, a dump truck is pulled by the tare weight, which causes the dump truck to move backward). In addition, because the motor output horsepower TrR, TrL corresponds to the operation amount p of the accelerator pedal 1 (the same tendency), excellent operational feeling can be achieved.

Thus, in this embodiment, because the operation amount of the accelerator pedal 1 is small, the horsepower which is applied to the electric motors 12R, 12L is small. However, when the traveling speed is low, and accordingly the motor revolution speed is small, it is possible to increase the torque to be applied to the electric motors 12R, 12L as much as possible. Therefore, it is possible to improve both the security and the operational feeling.

Moreover, in the case of the conventional electrically driven dump trucks, in order to facilitate the inverter control, when an accelerator pedal is pressed, the horsepower to be applied to the electric motors for traveling is often controlled in response to the accelerator operation amount with the operation of the prime mover kept at the maximum speed. Therefore, when the accelerator operation amount is small, the dump truck travels at low speed, which requires the low output of the prime mover. Nevertheless, fuel is uselessly consumed. In this embodiment, because both of the output of the prime mover and that of the electric motors are concurrently controlled in response to the accelerator operation amount as described above, it is possible to solve such a malfunction, and also to reduce the waste of energy.

In addition, according to this embodiment, in the blocks 200, 202 shown in FIG. 2, the target revolution speed Nr of the prime mover 4 is not directly determined from the operation amount p of the accelerator pedal 1. First of all, the target horsepower Fr of the prime mover 4 is calculated by the function Fr(p) (block 200). Then, by use of the target horsepower Fr, the target revolution speed Nr is calculated by the function Nr(Fr) that is an inverse function of f(Ne) shown in FIG. 7 (block 202). This makes it possible to correct the nonlinearity of the horsepower characteristics of the prime mover 4.

Subsequently, another embodiment of a drive system of an electrically driven dump truck according to the present invention will be described.

In the former embodiment, on the basis of the accelerator operation amount p, the target engine horsepower Fr and the target engine revolution speed are determined to perform the engine control. Then, when the target motor horsepower Mr is calculated on the basis of the actual revolution speed Ne of the engine 4, the correction coefficient Kp corresponding to the environment state quantity is used. However, in this embodiment, the target engine revolution speed Nr corresponding to the environment state quantity is calculated in the stage of the engine control beforehand. A hardware configuration of a dump truck is the same as that described in the above embodiment. Processing steps executed by the total control unit 3 and the inverter control unit 7 according to this embodiment will be specifically described as below.

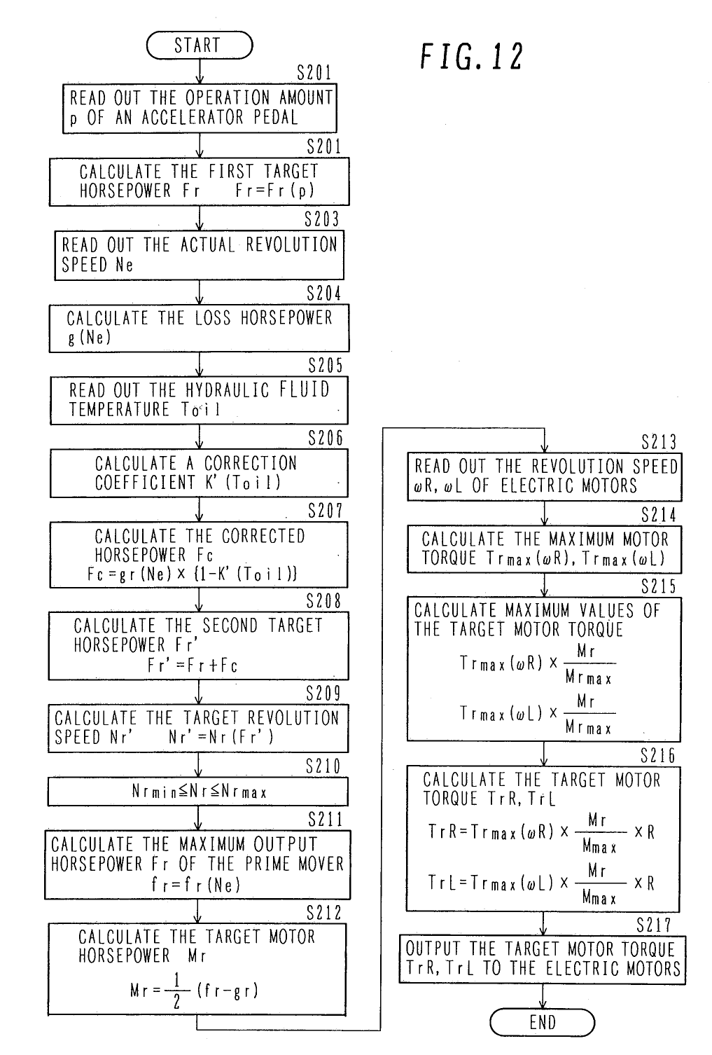

FIG. 11 is a functional block diagram illustrating the processing steps. FIG. 12 is a flowchart illustrating the processing steps. In FIG. 11, similar reference numerals are used to denote parts, which are similar to those illustrated in FIG. 2, or which play roles similar to those illustrated in FIG. 2, and therefore the description thereof will be omitted.

First of all, steps 201, 202 are similar to the steps 101, 102 shown in FIG. 3. The total control unit 3 calculates the target prime mover horsepower Fr corresponding to the accelerator operation amount p, and then defines the calculated target prime mover horsepower Fr as the reference target horsepower (first target engine horsepower) (a block 200 shown in FIG. 11).

Proceeding to a step 203, the total control unit 3 reads out the actual revolution speed Ne of the prime mover 4. Further, in a step 204, the total control unit 3 calculates the loss horsepower g(Ne) of the other prime mover loads 18 (refer to FIG. 7). The result of the calculation of the loss horsepower g(Ne) is also used for processing of the block 212.

In steps 205, 206, the total control unit 3 determines a correction coefficient K′(Toil).

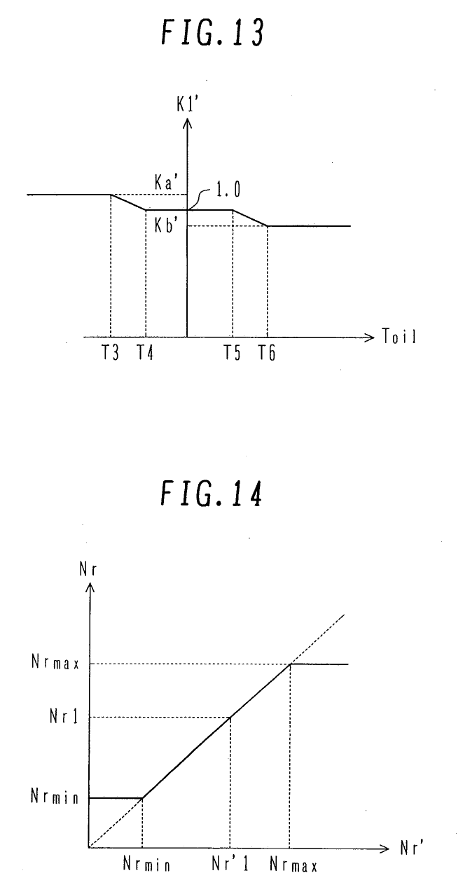

In the step 205, the hydraulic fluid temperature Toil is calculated from a detection signal s1 of the thermometer 20. Next, in the step 206, with reference to a memory map showing the relationship between the hydraulic fluid temperature and a correction coefficient shown in FIG. 13, the correction coefficient K′(Toil) corresponding to the calculated hydraulic fluid temperature Toil is determined.

In this embodiment, if the hydraulic fluid temperature Toil falls within a range of the predetermined standard temperature (from a lower limit T4 to an upper limit T5), the correction coefficient K′(Toil) is kept at a constant value (=1.0). In addition, if the hydraulic fluid temperature Toil falls within a range from the lower limit T4 (the standard temperature) to the set temperature T3 that is lower than the lower limit T4, the correction coefficient K′(Toil) increases from 1.0 up to Ka′ (>1.0) with the decrease in oil temperature. On the other hand, if the hydraulic fluid temperature Toil is lower than or equal to the set temperature T3, the correction coefficient K′(Toil) is set at a constant value that is equivalent to Ka′. In contrast with this, if the hydraulic fluid temperature Toil falls within a range from the upper limit T5 (the standard temperature) to the set temperature T6 that is higher than the upper limit T5, the correction coefficient K′(Toil) decreases from 1.0 to Kb′ (<1.0) with the increase in oil temperature. On the other hand, if the hydraulic fluid temperature Toil is higher than or equal to the set temperature T6, the correction coefficient K′(Toil) is set at a constant value that is equivalent to Kb′. However, the settings of this correction coefficient K′(Toil) are not limited to the mode shown in FIG. 13. The settings can be properly changed.

Proceeding to a step 207, the total control unit 3 uses the correction coefficient K′(Toil) to correct the loss horsepower g(Ne) which has been determined beforehand, and thereby calculates the corrected horsepower Fc as expressed by the following equation:

Fc=g(Ne)×{1−K′(Toil)}

Next, in the step 208, the total control unit 3 adds the corrected horsepower Fc to the reference target horsepower Fr of the prime mover, which has been determined beforehand, and thereby calculates the second target engine horsepower Fr′ (a block 240 show in FIG. 11), the calculation being expressed by the following equation:

Fr′=Fr+Fc

When the target revolution speed of the engine 4 is calculated, the loss horsepower g(Ne), which fluctuates in response to the environment state quantity (in this example, the hydraulic fluid temperature Toil), is estimated beforehand. The second target engine horsepower Fr′ is used to give an instruction of the engine revolution speed in response to the fluctuations in the required amount of the loss horsepower g(Ne).

In a step 209, as is the case with the step 108 shown in FIG. 3, the total control unit 3 refers to a data map showing the relationship between the target horsepower and the target revolution speed (refer to FIG. 6) to calculate the reference target revolution speed (the first target revolution speed) Nr′ of the prime mover 4 corresponding to the second target horsepower Fr′ (a block 242 shown in FIG. 11).

In a step 210, a judgment is made as to whether or not the reference target revolution speed Nr′, which has been calculated in the step 209, falls within a range between the minimum revolution speed Nrmin, and the maximum revolution speed Nrmax, of the prime mover 4. If it is judged that the reference target revolution speed Nr′ does not fall within the range, the reference target revolution speed Nr′ is subjected to limit processing by use of the minimum revolution speed Nrmin or the maximum revolution speed Nrmax. Then, the revolution speed, which has been calculated by the limit processing, is defined as the target revolution speed (the second target revolution speed) Nr to be output to the electronic governor 4a of the engine 4 (blocks 244, 246 shown in FIG. 11).

FIG. 14 is a diagram illustrating a relationship line that shows the relationship between the first target revolution speed and the second target revolution speed.

As shown in FIG. 14, if the first target revolution speed Nr′ falls with a range from the minimum revolution speed Nrmin (for example, 750 rpm) of the engine to the maximum revolution speed Nrmax (for example, 2000 rpm), the first target revolution speed Nr′ becomes the second target revolution speed Nr just as it is. However, if the first target revolution speed Nr′ exceeds the maximum revolution speed Nrmax, the total control unit 3 selects a lower one from the first target revolution speed Nr′ and the maximum revolution speed Nrmax, and then defines the maximum revolution speed Nrmax as the second target revolution speed Nr (a block 244 shown in FIG. 11). On the other hand, if the first target revolution speed Nr′ becomes lower than the minimum revolution speed Nrmin, the total control unit 3 selects a higher one from the first target revolution speed Nr′ and the minimum revolution speed Nrmin, and then defines the minimum revolution speed Nrmin as the second target revolution speed Nr (a block 246 shown in FIG. 11). The target revolution speed Nr, which has been acquired in this manner, is output to a governor 4a of the prime mover 4, and the fuel injection quantity is controlled according to the target revolution speed Nr. As a result, the engine revolution speed is controlled so that the engine revolution speed becomes close to the target revolution speed Nr.

In addition, proceeding to a step 211, on the basis of a data map showing the relationship between the revolution speed and the maximum output horsepower of the prime mover, which is defined by the function f(Ne) (refer to FIG. 7), the total control unit 3 calculates the maximum output horsepower f(Ne) of the prime mover 4 corresponding to the actual revolution speed Ne of the engine, which has been read out in the step 203 (block 210 shown in FIG. 2).

Subsequently, in a step 212, on the basis of the maximum output horsepower f(Ne) of the prime mover, which has been calculated in the step 211, and the loss horsepower g(Ne) assigned to the other prime mover loads 18, the total control unit 3 calculates the target motor horsepower Mr per electric motor (blocks 214, 216 shown in FIG. 2), the calculation being expressed by following equation:

Mr={f(Ne)−g(Ne)}/2

In subsequent steps 213 through 217, the target motor torque TrR, TrL is calculated by the inverter control unit 7, and processing relating to the control of the electric motors 12R, 12L is performed. However, because they are similar to those described in the steps 115 through 119 shown in FIG. 3, the description thereof will be omitted. The total control unit 3 and the inverter control unit 7 perform the driving control of the dump truck by repeatedly performing the steps 201 through 217 described above.

In this embodiment, by repeatedly executing the above-described control steps, the corrected horsepower Fc in consideration of the environment state quantity (Toil) is added to the calculation of the maximum output horsepower f(Ne) of the prime mover beforehand. For example, if the hydraulic fluid temperature decreases, which causes the viscosity of the hydraulic fluid to increase, the horsepower required to drive an oil hydraulic pump, which is used to drive hydraulic equipment, increases. Accordingly, the horsepower Mr, which can be assigned to the electric motors 12R, 12L for traveling, ought to become low. In this embodiment, for example, if the hydraulic fluid temperature is lower than the standard temperature range (Toil <T4), a correction coefficient K1 becomes larger than 1 (K1′>1). Accordingly, the corrected horsepower Fc whose value is negative is added so that the first target horsepower Fr is corrected in a decreasing direction. Consequently, the target engine revolution speed Nr decreases, and the actual engine revolution speed Ne also decreases. As a result, as understood from the chart shown in FIG. 7, the target motor horsepower Mr used for the electric motors 12R, 12L, which is calculated in the step 212, is decreased.

In contrast with this, if the hydraulic fluid temperature is high, which requires the increase in the target horsepower Mr of the electric motors 12R, 12L used for traveling, for example, if the hydraulic fluid temperature is higher than the standard temperature range (Toil <T5), the correction coefficient K1′ becomes smaller than 1 (K1′<1). Accordingly, the corrected horsepower Fc whose value is positive is added so that the first target horsepower Fr is corrected in an increasing direction. Consequently, the target engine revolution speed Nr increases, and the actual engine revolution speed Ne also increases. As a result, the target motor horsepower Mr used for the electric motors 12R, 12L, which is calculated in the step 212, increases.

As described in this embodiment, even if the consumed horsepower of the other prime mover loads 18, which is influenced by the environment state quantity, is taken into consideration not in a stage in which an instruction value used to control the electric motors 12R, 12L is calculated, but in a stage in which an instruction value used to control the engine 4 is calculated, it is possible to produce the same effects as those of the above embodiment that has already been described with reference to FIG. 3, and the like.

Incidentally, according to the configuration of this embodiment, the target motor torque TrR, TrL is determined irrespective of a position of the shift lever 16 (more specifically, irrespective of whether the dump truck is traveling forward or backward). However, as described in the above embodiment that has already been described with reference to FIG. 3, and the like, a method for determining the target motor torque TrR, TrL at the time of forward traveling may also differ from that for determining the target motor torque TrR, TrL at the time of backward traveling. In contrast with this, in the former embodiment, the target motor torque TrR, TrL may also be determined irrespective of a position of the shift lever 16 as described in this embodiment.

The embodiments of the present invention have been described. However, the design of the present invention can be changed in various ways within the scope of the technical thought of the present invention. Representative examples thereof will be described as below.

1. In the above-described embodiments, the correction coefficient is determined by use of the hydraulic fluid temperature Toil. However, the hydraulic fluid temperature Toil is influenced by the atmospheric temperature under working environment. Therefore, it may also be so configured that the atmospheric temperature is detected so as to prepare beforehand a memory map as shown in FIG. 8, before the correction coefficient is determined.

2. In addition, in the first embodiment described with reference to FIG. 3, and the like, the correction coefficient is determined by detecting the atmospheric pressure Patm. However, because a place in which the dump truck operates is usually known beforehand, if the second correction coefficient K2 is replaced with a constant value in response to the altitude of the operation place, it is possible to execute the control steps shown in FIG. 3 even if the memory map shown in FIG. 9 and the barometer 21 are not provided. Moreover, it is also thought that if the correction coefficient determined in response to the altitude is used for control, an altimeter, a GPS device, and the like, are provided, and on the basis of an input signal from them, the correction coefficient is calculated with reference to a memory map showing the relationship between the altitude and the correction coefficient that has been prepared beforehand.

For example, when a dump truck is operated in highlands, combustion air of fuel decreases, which causes the output of the prime mover to decrease. Therefore, heretofore, every time the dump truck is operated in highlands, it is necessary to adjust the output to be applied to electric motors so that the output level thereof becomes low. Also in this case, in this example, by applying the altitude (or the air density) as the environment state quantity that is used for the control, the assignment of the horsepower used for traveling is automatically adjusted in response to the altitude or the air density. As a result, it is also possible to eliminate the labor of adjustment as described above.

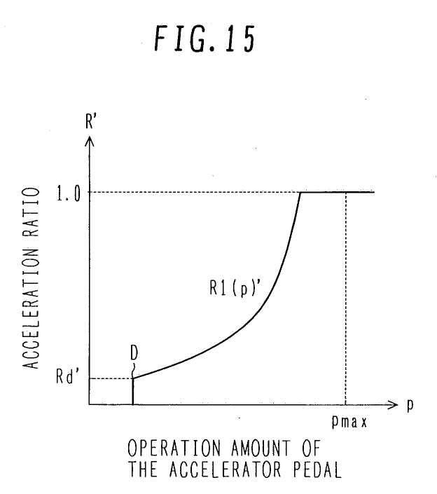

3. In addition, in the first embodiment, it is so configured that the target motor torque TrR, TrL corresponding to the accelerator operation amount p can be obtained in the step 118. In this case, as shown in FIG. 5, the acceleration ratio R1 is configured to smoothly increase in response to the accelerator operation amount p. As a result, in the step 118, the target motor torque TrR, TrL is also configured to smoothly increase in response to the accelerator operation amount p. However, the present invention is not limited to this example. As is the case with the function R1′(p) shown in FIG. 15, Rd′ (>0) is given as an initial value of the acceleration ratio at a point D (a point at which the change in acceleration ratio starts), which corresponds to the point A shown in FIG. 5, so that even if the accelerator operation amount p is low, the acceleration ratio is ensured to some degree. As a result, when an operator presses down the accelerator pedal 1 only to a small extent, the target motor torque TrR, TrL becomes higher. Therefore, it is possible to shorten the time delay before the dump truck actually starts traveling.

4. Moreover, in the blocks 210, 212, on the assumption that the maximum output horsepower and the loss horsepower are the functions f(Ne), g(Ne) of the actual revolution speed Ne of the prime mover 4 respectively, the maximum output horsepower and the loss horsepower are determined from the actual revolution speed Ne of the prime mover 4. However, because usually the accelerator pedal is not rapidly operated, Ne can be thought to be roughly equivalent to Nr (Ne=Nr). Therefore, on the assumption that the maximum output horsepower and the loss horsepower are functions f(Nr), g(Nr) of the target revolution speed Nr of the prime mover 4 respectively, the maximum output horsepower and the loss horsepower may also be determined from the target revolution speed Nr of the prime mover 4.

5. In the block 216, the total amount of horsepower, which may be used for traveling, is divided into equal parts, and thereby the target motor horsepower Mr used for each of the right and left electric motors 12R, 12L is estimated to be the same as each other. The target torque TrR, TrL of the right and left electric motors 12R, 12L is calculated on the basis of the actual motor revolution speed ωR, ωL respectively. However, it may also be so configured that the target horsepower Mr used for the right and left electric motors 12R, 12L is assigned on the basis of a ratio of the motor revolution speed ωR, ωL.

6. The case where two control units (the total control unit 3 and the inverter control unit 7) share the control steps shown in FIG. 3 and FIG. 13 is taken an example. However, it may also be so devised that one control unit handles all control steps; or it may also be so devised that three or more control units share the control steps.

7. Besides, although the electric motors 12R, 12L are induction motors, they may also be synchronous motors. It is also thought that, instead of using the alternating-current generator 5, a direct-current generator is used as the electric generator that is connected to the engine 4. The revolution speed ωR, ωL of the electric motors 12R, 12L, which is detected by the electromagnetic pickup sensors 15R, 15L, is used to calculate the target motor torques TrR, TrL respectively. However, for example, the revolution speed of a rotating shaft of each of the tires 14R, 14L may also be used. In addition, so long as the estimated horsepower for driving the other prime mover loads 18 is changed in response to the environment state quantity as described in the present invention, instead of the electronic governor 4a, a mechanical governor can also be adopted as the governor for controlling the fuel injection quantity of the engine. Even in such cases, the same effects can be achieved.

1. A drive system for an electrically driven dump truck which travels using the electric energy, the drive system comprising:
a prime mover;
an electric generator which is driven by said prime mover;
electric motors for traveling, each of which is driven by the electric power supplied from said electric generator;
inverters which are connected to said electric generator, and which control said electric motors;
other prime mover loads other than said electric generator, said other prime mover loads being driven by said prime mover;
measuring means for measuring the environment state quantity which fluctuates in response to ambient working environment;
correction coefficient calculation means for, on the basis of the correlation between the environment state quantity and a correction coefficient, the correlation being provided beforehand, calculating a correction coefficient (Kp) in response to the environment state quantity detected by said measuring means;
horsepower calculation means for calculating the maximum output horsepower (f(Ne)) which can be output by said prime mover, and the horsepower for driving said other prime mover loads (g(Ne)), on the basis of the target revolution speed of said prime mover or the actual revolution speed thereof;
maximum horsepower calculation means for correcting the horsepower for driving said other prime mover loads by use of the correction coefficient which has been calculated by said correction coefficient calculation means, and for subtracting the horsepower for driving said other prime mover loads after the correction from the maximum output horsepower which can be output by said prime mover, so as to determine the maximum horsepower (Mr) which can be used by said electric motors for traveling; and
inverter control means for determining the target torque (TrL, TrR) of said electric motors for the traveling on the basis of the maximum horsepower which can be used by said electric motors for traveling, the maximum horsepower having been calculated by said maximum horsepower calculation means, and for controlling said inverters on the basis of the calculated target torque.

2. A drive system for an electrically driven dump truck which travels using the electric energy, the drive system comprising:
a prime mover;
an electric generator which is driven by said prime mover;
electric motors for traveling, each of which is driven by the electric power supplied from said electric generator;
inverters which are connected to said electric generator, and which control said electric motors;
other prime mover loads other than said electric generator, said other prime mover loads being driven by said prime mover;
measuring means for measuring the environment state quantity which fluctuates in response to ambient working environment;
correction coefficient calculation means for, on the basis of the correlation between the environment state quantity and a correction coefficient, the correlation being provided beforehand, calculating a correction coefficient (K′(Toil)) in response to the environment state quantity detected by said measuring means;
corrected horsepower calculation means for calculating the corrected horsepower (FC) on the basis of the correction coefficient calculated by said correction coefficient calculation means, and the horsepower for driving said other prime mover loads (gr(Ne));
reference target horsepower calculation means for calculating the reference target horsepower (Fr) of said prime mover in response to the operation amount (p) of the accelerator pedal;
target horsepower calculation means for calculating the target horsepower (Fr′) of said prime mover by adding the corrected horsepower to the reference target horsepower which has been calculated by said reference target horsepower calculation means;
prime-mover target revolution speed calculation means for calculating the target revolution speed (Nr′) of said prime mover on the basis of the target horsepower which has been calculated by said target horsepower calculation means;
fuel injection quantity control means for controlling the fuel injection quantity of said prime mover so that the actual revolution speed (Ne) gets close to the target revolution speed which has been calculated by said prime-mover target revolution speed calculation means;
horsepower calculation means for calculating the maximum output horsepower (fr) which can be output by said prime mover, and the horsepower for driving said other prime mover loads (gr), on the basis of the target revolution speed of said prime mover or the actual revolution speed thereof;
maximum horsepower calculation means for subtracting the horsepower for driving said other prime mover loads from the maximum output horsepower which can be output by said prime mover, so as to determine the maximum horsepower (Mr) which can be used by said electric motors for traveling; and
inverter control means for determining the target torque (TrL, TrR) of said electric motors for the traveling on the basis of the maximum horsepower which can be used by said electric motors for traveling, the maximum horsepower having been calculated by said maximum horsepower calculation means, and for controlling said inverters on the basis of the calculated target torque.

3. The drive system for the electrically driven dump truck according to claim 1, wherein:
the environment state quantity includes the temperature (Toil) of hydraulic fluid used for said other prime mover loads; and
said measuring means includes a thermometer for detecting the temperature of the hydraulic fluid.

4. The drive system for the electrically driven dump truck according to claim 1, wherein:
the environment state quantity includes the ambient atmospheric pressure (Patm), and
said measuring means includes a barometer for detecting the atmospheric pressure.
